(19) United States
(12) Patent Application Publication
(10) Pub. No.: US 2009/0266125 A1
(43) Pub. Date: Oct. 29, 2009

(54) Plant Fertilizer Composition and Method of Making Same

(76) Inventor: An Tung Thien Doan, Irvine, CA (US)

Correspondence Address: BAKER & HOSTETLER LLP, WASHINGTON SQUARE, SUITE 1100, 1050 CONNECTICUT AVE. N.W., WASHINGTON, DC, 20036-5304, US

(21) Appl. No.: 12/430,418

(22) Filed: Apr. 27, 2009

Related U.S. Application Data
(60) Provisional application No. 61/048,387, filed on Apr. 28, 2008.

(51) Int. Cl. C05F 1/00; C05F 11/08

(52) U.S. Cl. 71/9; 71/16

(57) ABSTRACT

The present invention provides, in some embodiments, a plant fertilizing composition and a method of producing the plant fertilizer. Other embodiments of the invention provide natural, organic, non-pathogenic enzymes for soil and water immobilization and microencapsulated bacterial enzymatic complexes. Various embodiments of the invention are particularly suited for use in agriculture to increase the health and yield of crop plants. In other embodiments, the composition may be utilized to reduce waterborne contamination.

### CROSS REFERENCE TO RELATED APPLICATIONS

This application claims priority to U.S. Provisional Application Ser. No. 61/048,387, filed on Apr. 28, 2008, titled “PLANT FERTILIZER COMPOSITION AND METHOD OF MAKING SAME,” the disclosure of which is incorporated herein by reference in its entirety.

### FIELD OF THE INVENTION

The present invention relates generally to a plant fertilizing composition. More particularly, the present invention relates to a fertilizer composition and method for producing same.

### SUMMARY OF THE INVENTION

The foregoing needs are met, to a great extent, by the present invention, wherein in some embodiments a plant fertilizer and method for producing same are provided.

An embodiment of the present invention relates to a fish and seaweed based plant fertilizing composition.

Another embodiment of the present invention pertains to a method of generating a fertilizing agent. In this method, fresh fish and seaweed are ground and mixed and inoculated with a microorganism. The inoculated fish/seaweed mixture is fermented and a sufficient amount of sorbic acid is added to the fermented fish/seaweed mixture to increase shelf life.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### DETAILED DESCRIPTION OF THE INVENTION

Nitrogen fixing bacterium ‘fix’ or sequester nitrogen from the atmosphere and utilize the nitrogen to generate cell constituents. Nitrogen Fixation may be defined as a natural process, by which soil bacterium, algae and plants manufacture useable nitrogen for plants from the atmosphere. Nitrogen fixing bacteria include a diverse group of prokaryotes, reaching into phylogenetically distinct groups of archaea and bacteria. In general nitrogen fixing organisms are unified only on the basis of their metabolic ability to “fix” nitrogen or otherwise convert N₂ (atmospheric nitrogen) to a water soluble or other such form that is available for plant use such as, for example NH₃ (ammonia). Nitrogen fixation is a complicated enzymatic process mediated by the enzyme nitrogenase.

Nitrogenase is typically found in prokaryotes and is second only to Ribulose-1,5-bisphosphate (RuBP) carboxylase (the enzyme responsible for CO₂ fixation) as the most abundant enzyme on the planet. The conversion of nitrogen gas (which constitute about 80 percent of the atmosphere) to ammonia introduces nitrogen into the biological nitrogen cycle. Living cells obtain their nitrogen in many forms, but usually from ammonia (NH₃) or nitrates (NO₃) and typically not from N₂. Nitrogenase converts N₂ from the atmosphere and reduces it to NH₃ in a reaction that requires substantial reducing power (electrons) and energy (ATP). The NH₃ is typically assimilated into amino acids and proteins very quickly by subsequent cellular reactions. Thus, nitrogen from the atmosphere is fixed into living (organic) material. Although a widespread trait in bacteria, nitrogen fixation occurs in only a few select genera. Outstanding among them are the symbiotic bacteria Rhizobium and Bradyrhizobium which form nodules on the roots of legumes.

In this symbiosis the bacterium invades the root of the plant and fixes nitrogen which it shares with the plant. The plant provides a favorable habitat for the bacterium and supplies it with nutrients and energy for efficient nitrogen fixation

Rhizobium and Bradyrhizobium are gram-negative aerobes related to the pseudomonada. An unrelated bacterium, an actinomycete, enters into a similar type of symbiosis with plants. The actinomycete, Frankia, forms nodules on the roots of several types of trees and shrubs, including alders (Alnus), wax myrtles (Myrica) and mountain lilacs (Cenothus). They, too, fix nitrogen which they provide to their host in a useful form. This fact allows these species to be “pioneer plants” (among the first to colonize) in newly-forming nitrogen-deficient soils. Still other bacteria live in regular symbiotic associations with plants on roots or leaves and fix nitrogen for their hosts, but they do not cause tissue hyperplasia or the formation of nodules

Symbiotic cyanobacteria are likewise very important in nitrogen fixation. Cyanobacteria provide fixed nitrogen, in addition to fixed carbon, for their symbiotic partners which make up lichens. This enhances the capacity for lichens to colonize bare areas where fixed nitrogen is in short supply. In some parts of Asia, rice can be grown in the same paddles continuously without the addition of fertilizers because of the presence of nitrogen fixing cyanobacteria.

The different bacteria groups living in a concentrated solution including seaweed, calcium, amino acids, and protein are added to agriculture and aquaculture. Microorganisms: Azosporillum brasilense, Micrococcus spp., Nitrobacter spp., Nitrococcus spp., Nitrosomonas spp., Pseudomonas spp., Streptomyces spp., and Trichoderma spp. are also capable of fixing atmospheric nitrogen.

The present invention provides, in some embodiments, a plant fertilizing composition and a method of producing the plant fertilizer. Other embodiments of the invention provide natural, organic, non-pathogenic enzymes for soil and water immobilization and microencapsulated bacterial enzymatic complexes. Various embodiments of the invention are particularly suited for use in agriculture to increase the health and yield of crop plants. In other embodiments, the composition may be utilized to reduce soil and/or waterborne contamination.

Embodiments of the invention are natural, organic, and/or non-toxic. In general, the process described herein acting upon the starting ingredients also described herein are utilized to generate biopolymers that are non-pathogenic and may be 100% organic without the addition of petrochemicals or otherwise synthetically derived chemicals. Various embodiments may include immobilized and microencapsulated bacterial-enzymatic cell complexes resulting from the novel process. The bacterial-enzymatic cell complex is processed using any suitable materials. Examples of suitable materials include several different kinds of fishes and/or different kind of seaweed. These starting materials may be ground and/or mix together with water and bacteria and/or bacterial-derived enzymes. Together, these materials may be placed in a suitable container. In general, suitable containers include a gas pressure relief and/or gas-permeable materials suitable for retaining liquid. More particularly, these materials may include non-leaching, natural materials such as clay. The mixture of starting materials, water and bacteria and/or bacterial-derived enzymes may be incubated. In general, incubation may be allowed to proceed until completion. In a particular example, incubation or fermentation may be allowed to proceed for about 5-7 months at about 90-95° F. (32-35° C.).

In a particular example, the composition is produced by processing: 40% finely ground fresh fish, 39% fine grinded seaweed, 20% water, and 1% enzymes or micro-organisms. These components are combined and mixed and placed in a plastic, clay, and/or ceramic tank. The mix materials are left to ferment at an average temperature of 90-95° F. (32-35° C.). Completion of fermentation is expected to take approximately 6 months.

In various examples, any suitable fish, seaweed, and/or microorganism may be utilized. Specific examples of suitable fish include North Pacific Ocean yellow tail, Indiana sea sheep head, Indiana sea swallowtail Damselfish. Specific examples of suitable seaweed include, Kombu, Cottonii, Nori, Rhodophita Gel, Wakame, Red Algae.

If live micro-organisms are utilized, they may be selected for their transformation of nitrogen, phosphorus, potassium, and micronutrients. Other selection criteria may include production of natural antibiotics and plant growth hormones in addition to their general activity in the soil that benefits plants. Specific examples of suitable micro-organisms used in the solution include one or more of:

1. Rhizobium leguminosarum

2. Bradyrhizobium japonicum

3. actinomyces humiferus

4. Frankia spp.

5. Micrococcus luteus

6. Nitrobacter winogradskyi

7. Nitrococcus mobilis

8. Nitrosomonas europaea

9. Pseudomonasfluorescens

10. Streptomyces venezuelae

11. Trichoderma harzianum

Following fermentation, the resulting fertilizer (Hereinafter referred to as “OI Micro-Bio Fertilizer”) includes nutrients and/or micronutrients immobilized and/or microencapsulated in solution. In this or other embodiments the OI Micro-Bio Fertilizer may further include biopolymers such as, for example, polypeptides, polysaccharides, and the like. Other ingredients may include organic extracts and/or water.

In an embodiment of the invention, sorbic acid is added to the fermented OI Micro-Bio Fertilizer to facilitate greater shelf life. In a particular example, about 0.03% to about 0.1% sorbic acid weight/weight (w/w) is utilized to reduce metabolic activity of the micro organisms and/or enzymes in solution. In this manner, shelf life can be increased from about one month to about 12 months to about 18 months. In addition, the OI Micro-Bio Fertilizer may be sealed in a container that is air tight or otherwise reduces introduction of oxygen. Furthermore, the exposure to light is preferably reduced in order to increase shelf life.

In this or other embodiments, maximum beneficial characteristics of the OI Micro-Bio Fertilizer may be achieved by re-activating the OI Micro-Bio Fertilizer prior to use. In general, re-activation may be achieved by diluting the OI Micro-Bio Fertilizer in water and introducing a priming agent. Dilution may be performed by adding water for example in the amount of about 100 parts water to 1 part of the OI Micro-Bio Fertilizer. The priming agent may include any suitable sugar source such as, for example, sucrose, brown sugar, agave, molasses, etc. In a particular example, about 5 grams of sucrose or equivalent may be added to 1 gallon (3.75 liters) of diluted OI Micro-Bio Fertilizer. The diluted and primed OI Micro-Bio Fertilizer may be incubated for about 1 to 5 days at about 32-35° C. In general, dilution is performed to reduce the concentration of sorbic acid to below an inhibitory concentration. By priming and incubating the diluted OI Micro-Bio Fertilizer, the dormant micro organisms are activated to provide nitrogen fixation, toxin decomposition, and nutrient production. In this manner, the microbiological flora or the soil may be replenished or otherwise re-established.

In agriculture, OI Micro-Bio Fertilizer is formulated to help reduce soil compaction, soil erosion and to enhance water penetration. As a soil treatment, the OI Micro-Bio Fertilizer possesses moisture retention agents that help improve conditions by increasing water penetration and reducing moisture stress. This allows increased crop production through better water utilization and plant nutrition. The OI Micro-Bio Fertilizer promotes hydrophobic soils and therefore increased water retention. In this manner, the OI Micro-Bio Fertilizer reduces soil erosion and leads to greater water penetration per cubic foot. In addition, humic acid present in the OI Micro-Bio Fertilizer increases plant uptake of micro-nutrients. The OI Micro-Bio Fertilizer can be applied to all types of crop fields including rice, trees, fruits, and vines. The OI Micro-Bio Fertilizer may be dispersed with existing irrigation systems or mixed with diluted liquid fertilizers and used as a pre-plant injection. The OI Micro-Bio Fertilizer may also be used as a post plant side dressing and may be dispersed by ground or aerial broadcasting.

When applied, the OI Micro Bio Fertilizer remains stable on the soil for up to 3 weeks, until irrigation or cultivation draws it into the soil. Nitrogen fixation increases the number of essential bacteria necessary for plant growth. Natural micro-organisms assist in decomposition of organic matter that provides the bacteria with a fresh and consistent supply of nutrients. The OI Micro-Bio Fertilizer includes beneficial amounts of nitrogen, phosphorous, and potassium (“NPK”) which may be particularly useful for growing turf grass. Nitrogen fixation increases beneficial bacterial combinations leading to increased nitrogen fixation. The OI Micro-Bio Fertilizer includes calcium which is particularly beneficial for cell division, moisture uptake, and respiration activity of plants. The OI Micro-Bio Fertilizer may facilitate raising the pH to about 8 which may be beneficial to a wide variety of plants.

The use of seaweed in the OI Micro-Bio Fertilizer increases nutrients such as, for example amino acids, plant growth hormones and enzymes which increase plant health and reduce plant stress. Humate and seaweed liquid used to buffer the pH supports root growth and reduces the need for watering which increases granular efficiency. Hume helps loosen hard soil essential for moisture and air circulation. In aerating the soil, more moisture is retained and more components of the air can reach throughout the soil. Drainage is also improved naturally and leeching is reduced by establishing a self sustaining soil environment.

The OI Micro Bio Fertilizer is an all natural, 100% organic plant food concentrate. Benefits of using the OI Micro Bio Fertilizer include improved root growth, acceleration and increased development of native microorganisms present in the soil, increased availability of trace minerals and nutrients in the soil, and the like. Other benefits include, increased cation capacity reduced crusting and clotting of the soil, speeds the breakdown of organic matter and crop stubble, reduces alkalinity of soil, and the like. Yet other benefit of the OI Micro Bio Fertilizer is a decrease in detrimental insect population by as much as 45%. The OI Micro Bio Fertilizer increases nitrifying and nitrogen-fixing bacteria population in the soil by as much as 500%.

The OI Micro Bio Fertilizer facilitates proper fertilization in aquaculture environments and significantly increases fish production in ponds. Research has proven that the use of liquid fertilizer will effectively and efficiently increase the abundance of plankton and the availability of food for fish as the amount of aquatic insects and other aquatic life is increased. Also, plankton shades the pond and prevents the growth of rooted weeds.

Phosphate in the OI Micro Bio Fertilizer makes it more soluble in water than granular fertilizer. Therefore less of the OI Micro Bio Fertilizer is required to achieve the same results as granular fertilizer.

The OI Micro-Bio Fertilizer may be used to treat water to increase the population of fresh water species such as mollusks and fish in the ponds and lakes. The health and number of fresh water shrimps and many different fishes are especially improved by treatment with the OI Micro-Bio Fertilizer. The OI Micro-Bio Fertilizer aids in cleaner water in lakes, rivers, and pond waterways.

The OI Micro-Bio Fertilizer improves both salt and fresh water. In saltwater the OI Micro-Bio Fertilizer remains active at salt concentration of up to 35/1000th. Application of the OI Micro-Bio Fertilizer to ponds and lakes, positively effects the health of ponds and aquaculture environments for both long term and short term.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A method of generating a fertilizing agent, the method comprising steps of:
grinding a fresh fish;
grinding a portion of seaweed;
combining the ground fish with the ground seaweed to generate a fish/seaweed mixture;
inoculating the fish/seaweed mixture with a microorganism;
fermenting the inoculated fish/seaweed mixture;
adding a sufficient amount of sorbic acid to the fermented fish/seaweed mixture to increase shelf life.

2. The method of generating a fertilizing agent according to claim 1 further comprising:
activating the fermented fish/seaweed mixture.

3. The method of generating a fertilizing agent according to claim 2, further comprising:
diluting the fermented fish/seaweed mixture to decrease the concentration of the sorbic acid below an inhibiting threshold.

4. The method of generating a fertilizing agent according to claim 3, further comprising:
adding at least one of sucrose, brown sugar, agave, and molasses to the fermented fish/seaweed mixture to prime the diluted fermented fish/seaweed mixture.

5. The method of generating a fertilizing agent according to claim 4, further comprising:
incubating the diluted and primed fermented fish/seaweed mixture for about 1 to 5 days at about 32-35° C.

6. The method of generating a fertilizing agent according to claim 1, further comprising:
adding about 0.03% to about 0.1% sorbic acid weight/weight (w/w) to the fermented fish/seaweed mixture.

7. The method of generating a fertilizing agent according to claim 1, further comprising:
fermenting the inoculated fish/seaweed mixture at an average temperature of 32-35° C.

8. The method of generating a fertilizing agent according to claim 1, further comprising:
fermenting the inoculated fish/seaweed mixture for about 6 months.

9. The method of generating a fertilizing agent according to claim 1, further comprising:
grinding one or more of North Pacific Ocean yellow tail, Indiana sea sheep head, and Indiana sea swallowtail Damselfish

10. The method of generating a fertilizing agent according to claim 1, further comprising:
grinding one or more of Kombu, Cottonii, Nori, Rhodophita Gel, Wakame, and Red Algae.

11. The method of generating a fertilizing agent according to claim 1, further comprising:
inoculating the fish/seaweed mixture with one or more of Rhizobium leguminosarum, Bradyrhizobium japonicum, Actinomyces humiferus, Frankia spp., Micrococcus luteus, Nitrobacter winogradskyi, Nitrococcus mobilis, Nitrosomonas europaea, Pseudomonas fluorescens, Streptomyces venezuelae, and Trichoderma harzianum.

12. A fertilizing agent, the agent comprising:
a fish, ground finely;
a portion of seaweed, ground finely;
an inoculum of microorganism to ferment the fish and the seaweed;
a sufficient amount of sorbic acid to increase shelf life of the fermented fish and seaweed; and
an activating agent to re-activate the microorganism.

13. The fertilizing agent according to claim 12, further comprising:
a diluent to decrease the concentration of the sorbic acid below an inhibiting threshold.

14. The fertilizing agent according to claim 12, wherein the fish includes one or more of North Pacific Ocean yellow tail, Indiana sea sheep head, and Indiana sea swallowtail Damselfish

15. The fertilizing agent according to claim 12, wherein the seaweed includes one or more of Kombu, Cottonii, Nori, Rhodophita Gel, Wakame, and Red Algae

16. The fertilizing agent according to claim 1, wherein the seaweed includes one or more of Rhizobium leguminosarum, Bradyrhizobium japonicum, Actinomyces humiferus, Frankia spp., Micrococcus luteus, Nitrobacter winogradskyi, Nitrococcus mobilis, Nitrosomonas europaea, Pseudomonas fluorescens, Streptomyces venezuelae, and Trichoderma harzianum.

17. The fertilizing agent according to claim 12, further comprising about 40% finely ground fresh fish, about 39% fine grinded seaweed, about 20% water, and about 1% micro-organisms
